(19) United States
(12) Patent Application Publication
(10) Pub. No.: US 2019/0166249 A1
(43) Pub. Date: May 30, 2019

(54) ELECTRONIC DEVICE AND SCREEN CONTROLLING METHOD APPLIED THERETO

(71) Applicant: Chiun Mai Communication Systems, Inc., New Taipei (TW)

(72) Inventor: Hsueh-Tsen Tsai, New Taipei (TW)

(21) Appl. No.: 16/165,788

(22) Filed: Oct. 19, 2018

(30) Foreign Application Priority Data
Nov. 10, 2017 (CN) 201711107880.2

(51) Int. Cl. H04M 1/725; G06F 3/0488

(52) U.S. Cl. CPC H04M 1/72583; G06F 3/0488

(57) ABSTRACT

An electronic device includes a screen, a processor and a storage device communicatively coupled to the processor. The storage device storing computer-executable instructions. When executed by the processor, the instructions cause the processor to detect a touch motion in a preset area that is located in an edge area of the screen, determine whether the touch motion is a preset touch motion when the touch motion is detected in the preset area, and execute a first preset function corresponding to the touch motion when the touch motion is the preset touch motion. The first preset function is defined as generating and displaying a first shortcut icon of a prediction function corresponding to an application interface currently displayed on the screen according to a previous touch motion received by the application interface. A screen controlling method is also provided.

### FIELD

The disclosure generally relates to touch technology, and particularly to an electronic device and a screen controlling method applied thereto.

### BACKGROUND

One-handed operation of an electronic device such as a mobile phone is quite common. However, electronic devices are becoming larger in size as the display screens are appearing more frameless. Thus, one-handed operation of the electronic device may lead to inadvertent touches that may unintendedly open a software application. At the same time, current software design lacks context-awareness in a smart design. Improvement in the art is preferred.

### BRIEF DESCRIPTION OF THE FIGURES

Implementations of the present disclosure will now be described, by way of example only, with reference to the attached figures.

FIG. 1 is a system structure diagram illustrating an embodiment of an electronic device.

FIG. 2 is a functional block diagram illustrating an embodiment of a screen controlling system in the electronic device of FIG. 1.

FIG. 3 is a schematic diagram illustrating an embodiment of a preset area of the screen in the electronic device of FIG. 1.

FIG. 4 is a schematic diagram illustrating another embodiment of a preset area of the screen in the electronic device of FIG. 1.

FIG. 5 is a schematic diagram illustrating a first shortcut icon generated on the screen.

FIG. 6 is a schematic diagram illustrating a second shortcut icon generated on the screen.

FIG. 7 is a flow diagram illustrating an embodiment of a screen controlling method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

The term “comprising” when utilized, means “include, but is not limited to”; it specifically indicates open-ended inclusion or membership in the so-described combination, group, series and the like. The term “coupled” when utilized, means “either a direct electrical connection between the things that are connected, or an indirect connection through one or more passive or active intermediary devices, but is not limited to”.

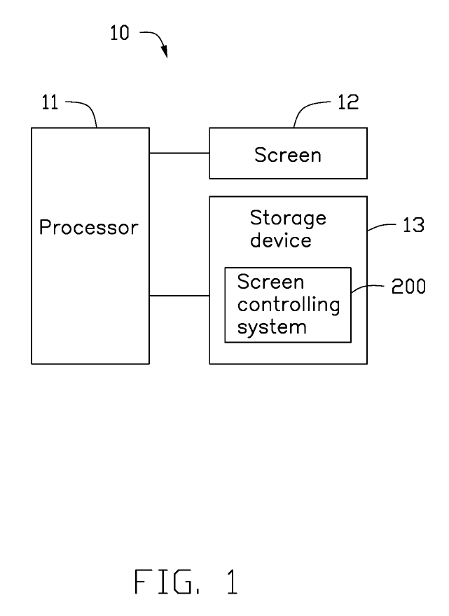

FIG. 1 shows an electronic device 10 in accordance with an embodiment. The electronic device 10 includes, but is not limited to, a processor 11, a screen 12, and a storage device 13. The electronic device 10 can be a portable electronic device such as a tablet computer, a mobile phone, a PDA (personal digital assistant) or other portable device. The electronic device 10 can include a full-screen display, the screen 12 can be part of the full-screen.

The processor 11 can be a central processing unit (CPU), a microprocessor, or other data processing chip.

The screen 12 is configured to provide an interactive interface to implement user interaction with the electronic device 10. The screen 12 is a touch screen for displaying the interactive interface, and sensing operations on the touch screen, generating corresponding electrical signals, and transmitting the electrical signals to the processor 11.

The storage device 13 is embedded in the electronic device 10. In an alternative embodiment, the storage device 13 can also be a separate external memory card, for example, an SM card (Smart Media Card), an SD card (Secure Digital Card), or the like.

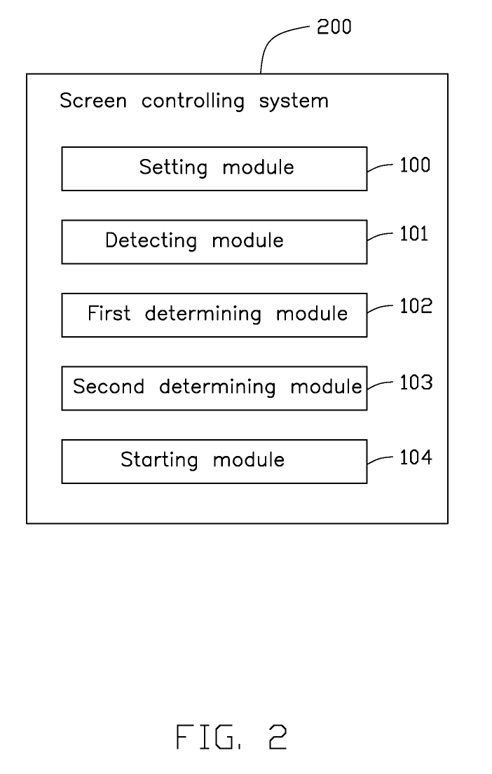

The screen controlling system 200 is installed and operated in the electronic device 10. The screen controlling system 200 can be divided into one or more modules, the one or more modules are computer-executable instructions stored in the storage device 13, and executed by the one or more processors 11, so that the electronic device 10 responds to operations on the screen 12 to implement interaction(s) between the user and the electronic device 10 according to the interactive interface. In FIG. 2, the screen controlling system 200 includes a setting module 100, a detecting module 101, a first determining module 102, a second determining module 103, and a starting module 104.

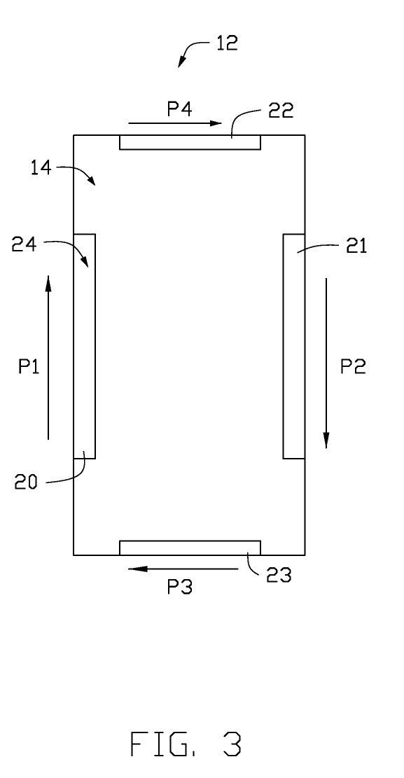

In the present embodiment, the detecting module 101 detects a touch motion in a preset area 24 (FIG. 3) that is located in an edge area of the screen 12.

In the present embodiment, referring to FIG. 3, the screen 12 includes a touch area 14, and the touch area 14 is roughly rectangular. The edge area includes a first edge area 20, a second edge area 21, a third edge area 22, and a fourth edge area 23. The first edge area 20, the second edge area 21, the third edge area 22, and the fourth edge area 23 are set along edges of the touch area 14. The first edge area 20 is opposite to the second edge area 21, and the third edge area 22 is opposite to the fourth edge area 23.

The preset area 24 is an area having a preset shape and a preset size in the first edge area 20, the second edge area 21, the third edge area 22, or the fourth edge area 23. The preset area 24 can approximate the portion or portions of a display screen likely to be touched by user fingertips during one-handed operation. The preset area 24 having a preset shape and a preset size can be a rectangular area having a preset length and a preset width. The preset length is preferably longer than the preset width. The preset area 24 extends in a direction along a lengthwise edge of the screen 12. In the present embodiment, the preset area 24 has a rectangular area that is perpendicular to a widthwise edge of the screen 12. The preset length is equal to or less than a length of the edge area.

Notably, there is only one preset area 24 in the present embodiment. That is, one preset area 24 covers only one of the first edge area 20, the second edge area 21, the third edge area 22, and the fourth edge area 23.

There can be multiple preset areas 24. That is, the multiple preset areas 24 can be provided in more than one of the first edge area 20, the second edge area 21, the third edge area 22, and the fourth edge area 23.

In general, when the electronic device 10 is vertically oriented, a longer side of the screen 12 is in the length direction and extends longitudinally, and a shorter side of the screen 12 is in the width direction and extends laterally. So, when the electronic device 10 is oriented along a longitudinal direction, the first edge area 20, the second edge area 21, the third edge area 22, and the fourth edge area 23 are respectively identified as a left edge area, a right edge area, an upper edge area, and a lower edge area of the screen 12. The preset area 24, when provided in the first edge area 20 or the second edge area 21, is a rectangular area extending along the length of the screen 12. The preset area 24, when provided in the third edge area 22 or the fourth edge area 23, is a rectangular area extending along the width of the screen 12.

When there are multiple preset areas 24, the multiple preset areas 24 can have same preset length and preset width, or can have different preset lengths and preset widths.

In the present embodiment, a preset touch motion is a slide gesture in a preset direction. The preset direction includes a first direction P1, a second direction P2, a third direction P3, and a fourth direction P4. The first direction P1 is opposite to the second direction P2, the third direction P3 is opposite to the fourth direction P4. The first direction P1 is perpendicular to the third direction P3 and the second direction P2 is perpendicular to the fourth direction P4. The slide gesture is defined as continuously touching the screen 12 for a preset time duration and then sliding on the screen 12 in a direction. The preset time can be preset in the storage device 13 by the setting module 100. For example, the preset time can be half a second, one second, or two seconds.

In a first embodiment, referring to FIG. 3, when the electronic device 10 is vertically oriented, the first direction P1 is a direction from bottom to top in the first edge area 20 and the second edge area 21. The second direction P2 is a direction from top to bottom in the first edge area 20 and the second edge area 21. The third direction P3 is a direction from right to left in the third edge area 22 and the fourth edge area 23. The fourth direction P4 a direction from left to right in the third edge area 22 and the fourth edge area 23.

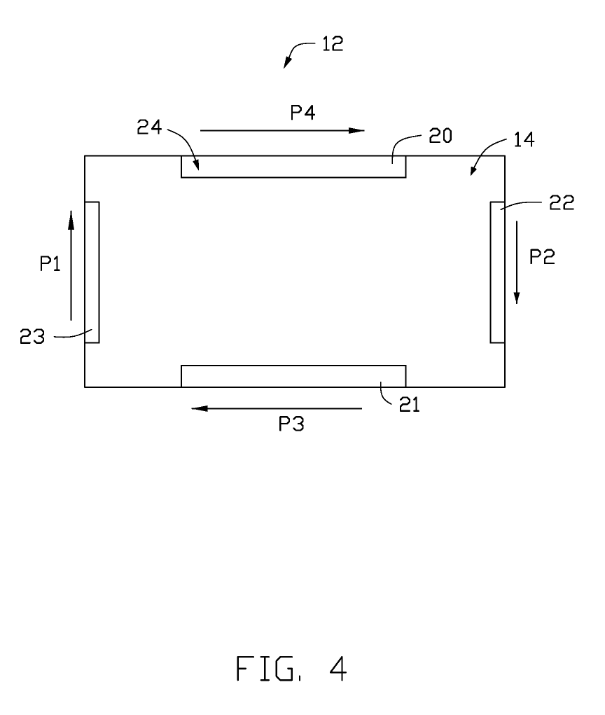

In a second embodiment, referring to FIG. 4, when the electronic device 10 is horizontally, the first edge area 20, the second edge area 21, the third edge area 22, and the fourth edge area 23 respectively correspond to the left edge area, the right edge area, the upper edge area, and the lower edge area of the screen 12. The preset area 24 provided in the first edge area 20 or the second edge area 21 is set as a rectangular area extending along the length of the screen 12, and the preset area 24 provided in the third edge area 22 or the fourth edge area 23 is set as another rectangular area that extends along the width of the screen 12. The first direction P1 is a direction from bottom to top in the third edge area 22 and the fourth edge area 23. The second direction P2 is a direction from top to bottom in the third edge area 22 and the fourth edge area 23. The third direction P3 is a direction from right to left in the first edge area 20 and the second edge area 21. The fourth direction P4 is a direction from left to right in the first edge area 20 and the second edge area 21.

In the present embodiment, the setting module 100 sets a preset function corresponding to the preset standard touches and touch motions. Each preset touch motion corresponds to one preset function. Each preset touch motion can be a first slide gesture, a second slide gesture, a third slide gesture, or a fourth slide gesture. The first slide gesture is the slide gesture along the first direction P1, the second slide gesture is the slide gesture along the second direction P2, the third slide gesture is the slide gesture along the third direction P3, and the fourth slide gesture is the slide gesture along the fourth direction P4. The preset function includes a first preset function, a second preset function, a third preset function, a fourth preset function, and a fifth preset function. Applications corresponding to the first preset function, the second preset function, the third preset function, the fourth preset function, and the fifth preset function are preset by the setting module 100 and stored in the storage device 13. The fourth preset function can vary while the fifth preset function remains unchanged as an application (app) interface changes. The setting module 100 can also change the preset functions corresponding to the preset touch motion in response to a user's operation.

In the present embodiment, the first determining module 102 is configured to determine whether the touch motion is a preset touch motion when a touch motion is detected in the preset area 24. When the detected touch motion matches the preset touch, then the first determining module 102 determines that the detected touch motion is a preset touch motion. When the first determining module 102 determines that the detected touch motion (a preset touch motion) is in the preset area 24, the second determining module 103 determines whether a current screen interface of the screen 12 is an application interface.

In the present embodiment, the screen 12 of the electronic device 10 can display two kinds of interfaces, namely the application interface and a system display interface. The application interface belongs to or related to one or other application installed in the electronic device 10. The system display interface belongs to or related to an operating system of the electronic device 10.

In the present embodiment, when the current screen interface of the screen 12 is the system display interface and the touch motion is the first slide gesture, the starting module 104 executes the first preset function. When the current screen interface of the screen 12 is the system display interface and the touch motion is the second slide gesture, the starting module 104 executes the second preset function. The first preset function and the second preset function can include functions such as volume adjustment, dialing to a contact, executing a preset application, or the like. For example, in one embodiment, the first preset function is defined as increasing a volume, the second preset function is defined as decreasing the volume. In a second embodiment, the first preset function is defined as immediately dialing to the telephone number of a preset contact, the second preset function is defined as immediately executing a WECHAT® application. For example, when the current screen interface of the screen 12 is the system display interface and the touch motion is the first slide gesture, the starting module 104 dials the preset contact immediately. When the current screen interface of the screen 12 is the system display interface and the touch motion is the second slide gesture, the starting module 104 immediately executes the WeChat® application.

In the present embodiment, when the current screen interface of the screen 12 is the system display interface and the touch motion is the third slide gesture or the fourth slide gesture, the starting module 104 executes the third preset function. The third preset function can be the preset function such as executing an album application or executing a browser. When a plurality of browser applications are installed in a system, the third preset function can be defined as immediately executing a preset browser. For example, in one embodiment, the third preset function is defined as immediately executing the album application. When the current screen interface of the screen 12 is the system display interface and the touch motion is the third slide gesture or the fourth slide gesture, the starting module 104 executes the album application. In a second embodiment, the third preset function is defined as immediately executing the browser. When the current screen interface of the screen 12 is the system display interface and the touch motion is the third slide gesture or the fourth slide gesture, the starting module 104 executes the browser.

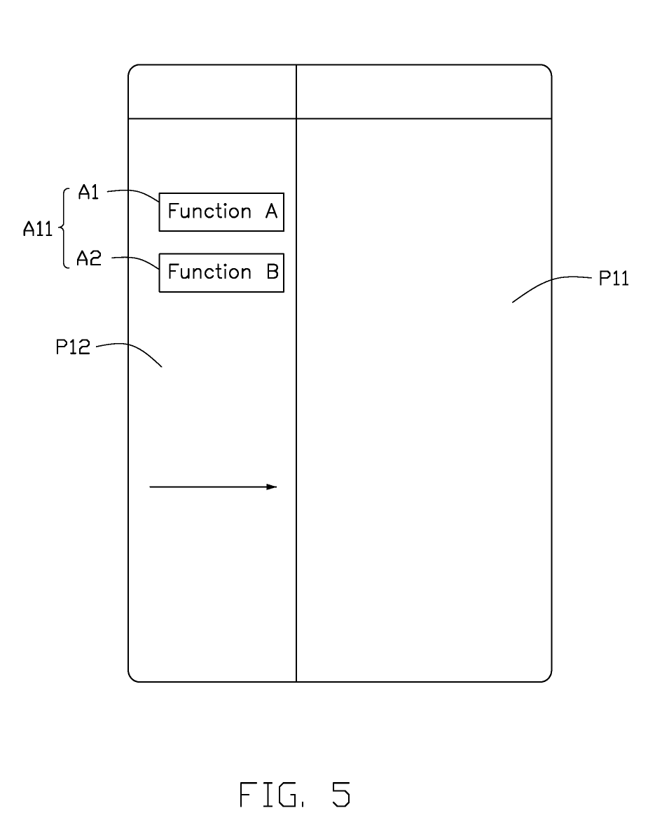

In the present embodiment, when the current screen interface of the screen 12 is the application interface and the touch motion is the third slide gesture or the fourth slide gesture, the starting module 104 executes the fourth preset function. The fourth preset function can be defined as generating a first shortcut icon A11 of a prediction function corresponding to a function provided by the application interface currently displayed on the screen 12. Referring to FIG. 5, an arrow indicates the third slide gesture or the fourth slide gesture as triggering the fourth preset function, the current screen interface of the screen 12 is the application interface P11. When the starting module 104 executes the fourth preset function, an overlay menu P12 will be generated to overlay the application interface P11. The overlay menu P12 can include the first shortcut icon A11, the first shortcut icon A11 includes A1 and A2, that is, function A shortcut icon A1 and function B shortcut icon A2. The function can operation a function related to the application interface. The first shortcut icon A11 can be preset in the storage device 13 by the setting module 100. The first shortcut icon A11 that appears each time the fourth preset function is executed is not fixed, and it will change with the current application type and the touch motion received by the current application interface. The first shortcut icon A11 includes, but is not limited to, notepad, storage and editing.

In a first embodiment, when the current screen interface of the screen 12 is a text application interface, the text application interface receives a first touch motion. For example, the first touch motion is to select or copy a piece of text. Then there is a second touch motion in the preset area 24, and the second touch motion is the third slide gesture or the fourth slide gesture, the starting module 104 generates and displays the first shortcut icon A11 corresponding to the text application interface according to the first touch motion, such as providing functions such as notepad, storage, and copying for the user to choose.

In a second embodiment, when the current screen interface of the screen 12 is a photo application interface, the photo application interface receives the first touch motion. For example, the first touch motion is to select or copy a photo. Then if there is a second touch motion in the preset area 24, and if the second touch motion is the third slide gesture or the fourth slide gesture, the starting module 104 generates and displays the first shortcut icon A11 of the prediction function corresponding to the photo application interface according to the first touch motion, such as providing notepad, sharing, and editing functions for the user to choose.

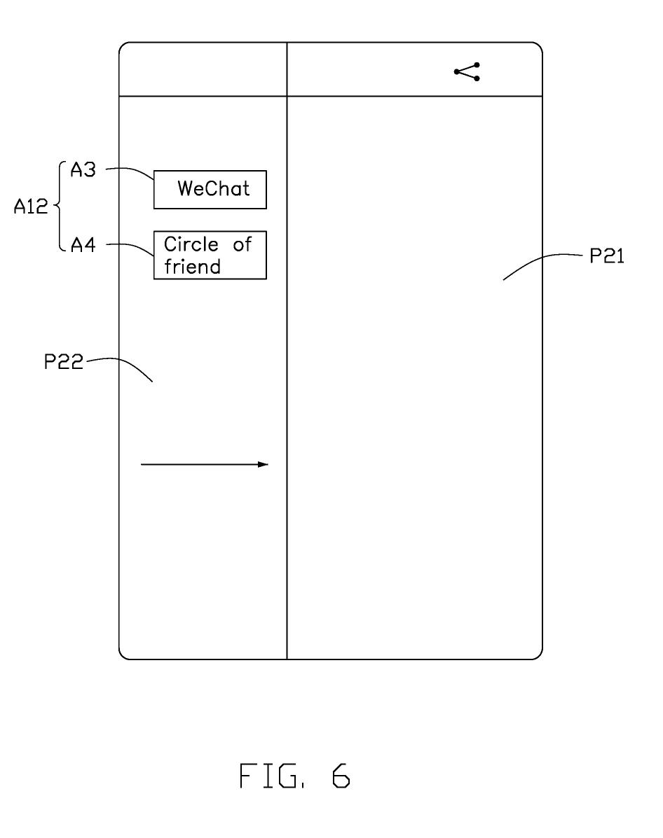

In a third embodiment, when the current screen interface of the screen 12 is the application interface and the touch motion is the third slide gesture or the fourth slide gesture, the starting module 104 executes the fifth preset function. The fifth preset function can be defined as generating a second shortcut icon A12 corresponding to a function operation of the application interface. The second shortcut icon A12 can include, but is not limited to, forwarding. Referring to FIG. 6, an arrow indicates the third slide gesture or the fourth slide gesture as triggering the fifth preset function, the current screen interface of the screen 12 is the application interface P21. When the starting module 104 executes the fifth preset function, an overlay menu P22 is generated to overlay the application interface P21. The overlay menu P22 can include the second shortcut icon A12, the second shortcut icon A12 includes A3 and A4, and separately represent the function of forwarding to WeChat® and the function of forwarding to a circle of friends.

For example, in one embodiment, when the current screen interface of the screen 12 is the application interface with the forwarding function and the touch motion is the third slide gesture or the fourth slide gesture, the starting module 104 generates the second shortcut icon A12 corresponding to the forwarding function. Forwarding function may be, for example, providing the function of forwarding information to a friend, a circle of friends, or a social networking site for the user to choose to make a forwarding action. No matter the application, the second shortcut icon A12 can provide a consistent forwarding operation interface. That is, consistent forwarding operation between an operation interface and an operation procedure. So that the user does not need to find complicated functions such as the forwarding function in the current application interface or copying web links.

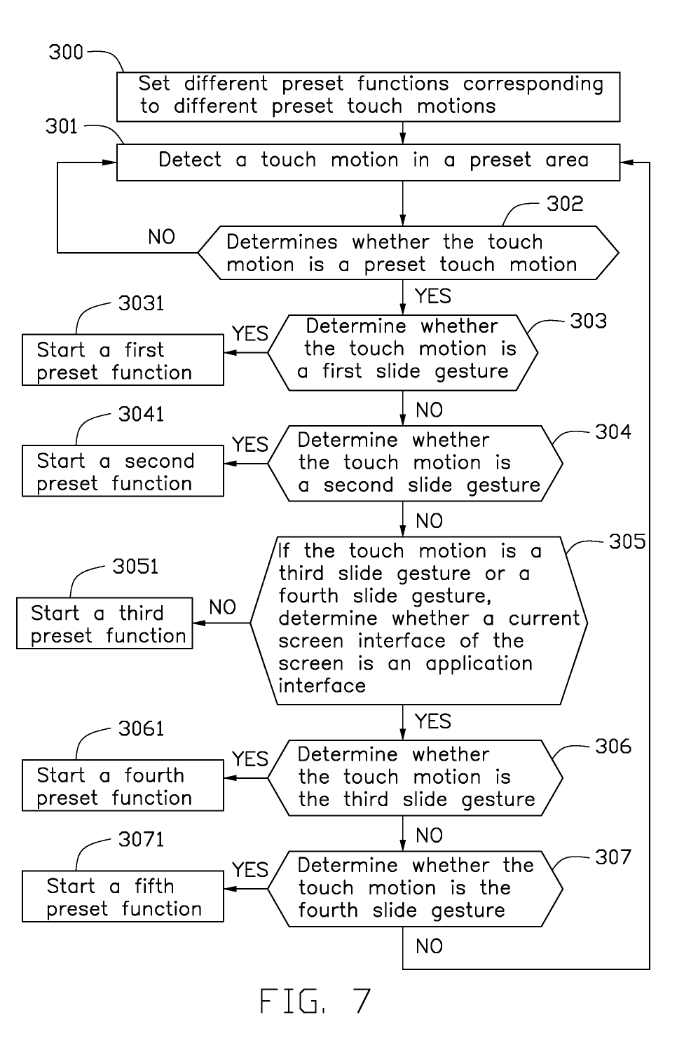

Referring to FIG. 7, a flowchart of an embodiment of screen controlling method is presented. The method is provided by way of example, as there are a variety of ways to carry out the method. The method described below can be carried out using the configurations illustrated in FIG. 2, for example, and various elements of these figures are referenced in explaining example method. Each block shown in FIG. 7 represents one or more processes, methods, or subroutines, carried out in the method. Additionally, the illustrated order of blocks is by example only and the order of the blocks can be changed. The method can begin at block 300. Depending on the embodiment, additional blocks can be added, others removed, and the ordering of the blocks can be changed.

At block 300, the setting module 100 sets different preset functions corresponding to different preset touch motions.

At block 301, the detecting module 101 detects a touch motion in a preset area 24, and the preset area 24 is located in an edge area of the screen. If no touch motion is detected, the detecting module 101 keeps detecting a touch motion at block 301. If a touch motion is detected, then the detecting module 101 proceeds to block 302.

At block 302, the first determining module 102 determines whether the touch motion is a preset touch motion. If the first determining module 102 determines that the touch motion is not a preset touch motion, then the first determining module 102 return to block 301; and if the first determining module 102 determines that the touch motion is a preset touch motion, then the first determining module 102 proceeds to block 303.

At block 303, the first determining module 102 determines whether the touch motion is a first slide gesture. If the touch motion is the first slide gesture, then enter into block 3031; if the touch motion is not the first slide gesture, then the first determining module 102 proceeds to block 304.

At block 3031, the starting module 104 executes a first preset function.

At block 304, the first determining module 102 determines whether the touch motion is a second slide gesture. If the touch motion is the second slide gesture, then the first determining module 102 proceeds to block 3041; if the touch motion is not the second slide gesture, then the first determining module 102 proceeds to block 305.

At block 3041, the starting module 104 executes a second preset function.

At block 305, if the touch motion is a third slide gesture or a fourth slide gesture, the second determining module 103 determines whether a current screen interface of the screen 12 is an application interface. If the second determining module 103 determines that the current screen interface of the screen 12 is not the application interface, that is, the current screen interface of the screen 12 is a system display interface, then the current screen interface of the screen 12 is the application interface, then the second determining module 103 proceeds to block 306.

At block 3051, the starting module 104 executes a third preset function.

At block 306, the first determining module 102 determines whether the touch motion is the third slide gesture. If the touch motion is the third slide gesture, then the first determining module 102 proceeds to block 3061; if the touch motion is not the third slide gesture, then the first determining module 102 proceeds to block 307.

At block 3061, the starting module 104 executes a fourth preset function.

At block 307, the first determining module 102 determines whether the touch motion is the fourth slide gesture. If the touch motion is the fourth slide gesture, then the first determining module 102 proceeds to block 3071; if the touch motion is not the fourth slide gesture, then the first determining module 102 return to block 301.

At block 3071, the starting module 104 executes a fifth preset function.

In another embodiment, the preset functions performed at the block 3061 and 3071 can be interchanged. That is, the starting module 104 executes the fifth preset function at block 3061, and the starting module 104 executes the fourth preset function at block 3071.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. An electronic device, comprising:
a screen;
a processor; and
a storage device communicatively coupled to the processor, the storage device storing computer-executable instructions, when executed by the processor, the instructions causing the processor to:
detect a touch motion in a preset area defined in an edge area of the screen;
determine whether the touch motion is a preset touch motion when the touch motion is detected in the preset area; and
execute a first preset function corresponding to the touch motion when the touch motion is the preset touch motion, the first preset function is defined as generating and displaying a first shortcut icon of a prediction function corresponding to an application interface currently displayed on the screen according to a previous touch motion received by the application interface.

2. The electronic device of claim 1, wherein the preset touch motion is a slide gesture in a preset direction, and the slide gesture is defined as continuously touching the screen for a preset time duration and then sliding on the screen in a direction.

3. The electronic device of claim 1, wherein the instructions further cause the processor to:
execute a second preset function when the touch motion is a first slide gesture, the second preset function is defined as immediately dialing a telephone number of a preset contact; and
execute a third preset function when the touch motion is a second slide gesture, the third preset function is defined as immediately executing a preset application.

4. The electronic device of claim 1, wherein the instructions further cause the processor to:
determine whether a current screen interface of the electronic device is the application interface;
execute a third preset function when the current screen interface of the electronic device is not the application interface and the touch motion is a third slide gesture or a fourth slide gesture, the third preset function is defined as immediately executing a preset application;
execute the first preset function when the current screen interface of the electronic device is the application interface and the touch motion is the third slide gesture; and
execute a fourth preset function when the current screen interface of the electronic device is the application interface and the touch motion is the fourth slide gesture.

5. The electronic device of claim 4, wherein the fourth preset function is defined as generating and displaying a second shortcut icon corresponding to a function provided by the application interface currently displayed on the screen.

6. A screen controlling method executed by an electronic device, the screen controlling method comprising:
detect a touch motion in a preset area defined in an edge area of the screen;
determine whether the touch motion is a preset touch motion when the touch motion is detected in the preset area; and
execute a first preset function corresponding to the touch motion when the touch motion is the preset touch motion, the first preset function is defined as generating and displaying a first shortcut icon of a prediction function corresponding to an application interface currently displayed on the screen according to a previous touch motion received by the application interface.

7. The screen controlling method of claim 6, wherein the screen controlling method further comprises:
the preset touch motion is a slide gesture in a preset direction, and the slide gesture is defined as continuously touching the screen for a preset time duration and then sliding on the screen in a direction.

8. The screen controlling method of claim 6, the block of determine whether the touch motion is a preset touch motion when a touch motion is detected in the preset area comprises:
execute a second preset function when the touch motion is a first slide gesture, the second preset function is defined as immediately dialing a telephone number of a preset contact; and
execute a third preset function when the touch motion is a second slide gesture, the third preset function is defined as immediately executing a preset application.

9. The screen controlling method of claim 6, wherein the screen controlling method further comprises:
determine whether a current screen interface of the electronic device is the application interface;
execute a third preset function when the current screen interface of the electronic device is not the application interface and the touch motion is a third slide gesture or a fourth slide gesture, the third preset function is defined as immediately executing a preset application;
execute the first preset function when the current screen interface of the electronic device is the application interface and the touch motion is the third slide gesture; and
execute a fourth preset function when the current screen interface of the electronic device is the application interface and the touch motion is the fourth slide gesture.

10. The screen controlling method of claim 9, wherein the fourth preset function is defined as generating and displaying a second shortcut icon corresponding to a function provided by the application interface currently displayed on the screen.

11. A non-transitory computer-readable medium storing a set of instructions, when executed by at least one processer, the instructions causing the at least one processor to:
detect a touch motion in a preset area dined in an edge area of the screen;
determine the touch motion is a preset touch motion when the touch motion is detected in the preset area; and
execute a first preset function corresponding to the touch motion when the touch motion is the preset touch motion, the first preset function is defined as generating and displaying a first shortcut icon of a prediction function corresponding to an application interface currently displayed on the screen according to a previous touch motion received by the application interface.

12. The non-transitory computer-readable medium of claim 11, wherein the preset touch motion is a slide gesture in a preset direction, and the slide gesture is defined as continuously touching the screen for a preset time duration and then sliding on the screen in a direction.

13. The non-transitory computer-readable medium of claim 11, wherein the instructions further cause the at least one processor to:
execute a second preset function when the touch motion is a first slide gesture, the second preset function is defined as immediately dialing a telephone number of a preset contact; and
execute a third preset function when the touch motion is a second slide gesture, the third preset function is defined as immediately executing a preset application.

14. The non-transitory computer-readable medium of claim 11, wherein the instructions further cause the at least one processor to:
determine whether a current screen interface of the electronic device is the application interface;
execute a third preset function when the current screen interface of the electronic device is not the application interface and the touch motion is a third slide gesture or a fourth slide gesture, the third preset function is defined as immediately executing a preset application;
execute the first preset function when the current screen interface of the electronic device is the application interface and the touch motion is the third slide gesture; and
execute a fourth preset function when the current screen interface of the electronic device is the application interface and the touch motion is the fourth slide gesture.

15. The non-transitory computer-readable medium of claim 14, wherein the fourth preset function is defined as generating and displaying a second shortcut icon corresponding to a function provided by the application interface currently displayed on the screen.
